(19) United States
(12) Patent Application Publication
(10) Pub. No.: US 2008/0017498 A1
(43) Pub. Date: Jan. 24, 2008

(54) Seawater Desalination Plant

(76) Inventor: Peter Szynalski, Karlsfeld (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/662,861

(22) PCT Filed: Sep. 14, 2005
(86) PCT No.: PCT/DE05/01608

§ 371 Date: Jul. 9, 2007

(30) Foreign Application Priority Data
Sep. 17, 2004 (DE) 10 2004 045 581.3

(51) Int. Cl. C02F 1/06

(52) U.S. Cl. 202/167; 202/172; 202/174

(57) ABSTRACT

The invention provides a seawater desalination plant including a cascade of evaporation units that are connected by a line system which guides the saltwater. Each cascade unit can be impinged upon by low pressure. The seawater is guided to the evaporation unit after having been directed through the cascades so that it can be successively evaporated. In order to improve the energy balance of the plant, an arrangement of heat exchangers (WT) is placed in at least the saltwater supply line and a heat pump (WP) is connected to one or several heat exchangers (WT).

### BACKGROUND OF THE INVENTION

Operating seawater desalination plants using a multistage flash (MSF) process, which is based on the principle of vacuum evaporation, is known. To ensure that the required energy is utilized efficiently, commercial desalination processes are designed so that the distillation process is repeated in several stages. The pressure and temperature level is successively lowered from stage to stage.

After a minor chemical treatment to prevent deposits, the incoming salt water (saline feed water) is progressively heated in a preheat section (tube bundle heat exchanger) and is directed to the end heater (brine heater). In the end heater, the water is heated to 90° C.-110° C. using heat energy (typically steam). A higher temperature is not desirable because calcium sulfate (CaSO₄) dissolves from the salt water at 115° C. and leads to thick deposits that can cause the plant to shutdown.

The heated water is then sent to a first evaporation stage. The ambient pressure of the first evaporation stage is reduced so that a part of the water is flash evaporated (flashing). The water vapor condenses in the tube bundle heat exchanger and additionally heats the counterflowing salt water. The resulting distillate is collected and separately diverted. The remaining brine is pumped to the next evaporation stage vessel in which the same process is repeated at a lower pressure and temperature level. Typical MSF plants have between 15 and 25 stages and produce between 4,000 and 100,000 m³ of fresh water per day.

Other methods that can be used for seawater desalination include multi-effect distillation (MED) and reverse osmosis at a membrane (reverse osmosis or RO).

The following are some consideration concerning the energy and economic assessment of seawater desalination plants. Most of the large scale seawater desalination plants that have been built are distillation plants which require low pressure steam as a heat source. Therefore, it can be important from a thermodynamic and economic standpoint to combine seawater desalination plants and power plants into combined plants in which the high pressure steam that is generated is used to produce electrical current in a turbogenerator and the low pressure waste steam or discharge steam from the steam turbines is used to supply the distillation plant. The construction and operation of such a combined plant is very costly. The owners and operators of these combined plants must take into account many relevant factors in choosing the technically and economically best plant combination and a fair distribution of total production costs into electricity and drinking water prices.

The following table can help in the energy requirements of seawater desalination processes:

| Process | Thermal Energy | Electrical Energy |
|---|---|---|
| MSF | 45-120 kWh/m³ | 3-6 kWh/m³ |
| MED | 48-350 kWh/m³ | 1.3-3.5 kWh/m³ |
| RO | — | 4-8 kWh/m³ |

Based on the analysis of the energy requirements, the membrane method (RO) is clearly better than the thermal methods (MSF, MED) since thermal energy is required only in the distillation methods. The ranges indicated in the table are dependent upon the plant type and size, since the specific energy requirement decreases with increasing plant efficiency (plant type) and increasing amount of steam (plant size).

The following table is useful with regards to the economic evaluation of seawater desalination methods:

| Method | Cost of Producing Drinking Water |
|---|---|
| MSF | 1.1-1.28 $/m³ |
| MED | 0.8-0.88 $/m³ |
| RO | 0.75-0.85 $m³ |

Based on the economic evaluation, the membrane method (RO) is not clearly better than the thermal method MED since the maintenance costs are lower with the distillation methods. In particular, the filters used in the membrane method only have a life span of 5 years, which leads to high costs. The ranges indicated in the table are not dependent on plant type and size, but rather on the form of energy that is used (gas, oil, nuclear energy).

In sum, there are various items that should be taken into account in selecting the process to be used when designing a seawater desalination plant.

### BRIEF SUMMARY OF THE INVENTION

In view of the foregoing, the following can be important criteria with respect to the design of a seawater desalination plant:
1. Desalination of seawater to the highest possible purity.
2. Minimizing energy consumption.
3. Using a proven method.
4. Sizing potential for medium size consumption.
5. Possibility of using freely accessible technologies.
6. Utilizing process improvements achieved through new technologies.

The following criteria weigh in favor of utilizing thermal processes:
Item 1, since a residual salt content of <50 ppm can be achieved;
Item 3, since it is a well tested technology that has been in use for about 50 years;
Item 4, since the required sizing processes are quite well developed; and
Item 5, since there is already considerable know-how with regards to the metalworking that is used.

The following criteria weigh in favor of the reverse osmosis methods:
In accordance with Item 2, only electrical energy is required, but the high ongoing costs for maintenance and continuous operation are disadvantages that can be particular issues in the case of small plants.

However, the use of new techniques for process improvement is the determinative factor with respect to the present invention. Specifically, the techniques concerning modular thermal power plants and heat pumps that have been introduced in recent years is the deciding factor in choosing the MSF method as the basis for a new medium size desalination plant (MSDP) according to the present invention. To this end, a general object of the invention is to provide an energy efficient and low cost plant utilizing these technical improvements in known seawater desalination methods. The present invention provides a plant utilizing the MSF technique for desalination, a connected heat pump and a modular thermal power plant for generating the thermal and electrical energy required to operate the MSF stages and the necessary pumps and control devices.

Thus, the plant can thus be operated autonomously, except for the required fossil fuels. Solar energy can support the operation of the plant or the plant can be solely operated by solar energy. By making the plant an appropriate size, it is also possible to generate excess electrical energy.

Below the invention is explained in connection with exemplary embodiments as well as illustrative figures.

### BRIEF DESCRIPTION OF THE SEVERAL VIEWS OF THE DRAWINGS

FIG. 1 is a schematic diagram of an exemplary vacuum evaporation or cascade unit.

FIG. 2 is a schematic diagram of an illustrative seawater desalination plant according to the invention.

FIG. 3 is a table setting forth an exemplary thermodynamic analysis of an MSF cascade.

FIG. 4 is a schematic diagram of a heat pump of the seawater desalination plant of FIG. 2.

FIG. 5 is a schematic diagram of a block type thermal power station of the seawater desalination plant of FIG. 2.

FIG. 6 is a schematic graph showing the energy balance of a desalination plant according to the invention.

FIG. 7 is a schematic graph showing the heat recovery of a desalination plant according to the invention.

### DETAILED DESCRIPTION OF THE INVENTION

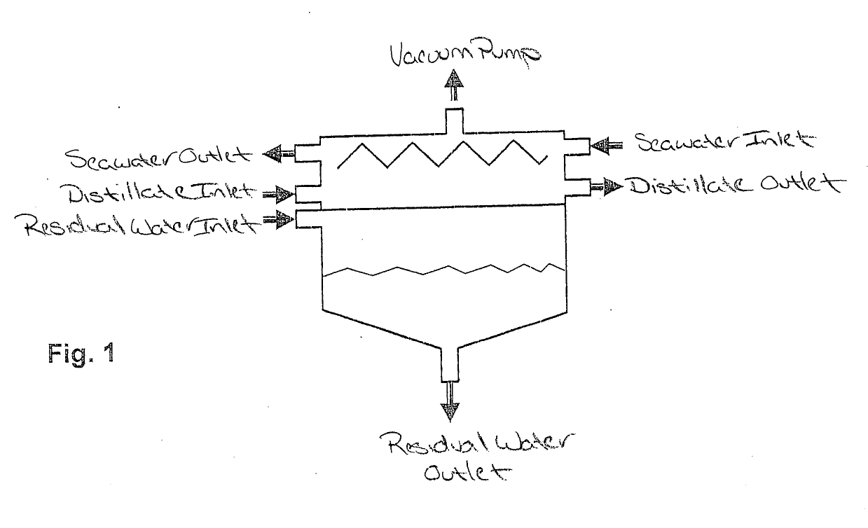

The desalination plant of the present invention is based on the method of evaporation in order to keep desalination process as free of residue as possible. A stepwise pressure reduction or multistage flash technology is used as the basic method. Referring to FIG. 1 of the drawings, the structure of an exemplary vacuum evaporation or cascade vessel or unit for the plant is shown. The following descriptions pertain to FIG. 1:
Seawater inlet: Seawater (saltwater) coming from the previous stage. This water causes condensation of the vapor in the heat exchanger.
Seawater outlet: Heated seawater (saltwater) sent to the next stage.
Residual water inlet: Partially evaporated seawater coming from the previous stage, which is then evaporated further.
Residual water outlet: Cooled, partially evaporated seawater that could not be evaporated and that is sent to the next stage.
Vacuum pump: Connection to a vacuum pump that provides the necessary reduced pressure for evaporation via a control valve.

To compensate for disadvantages associated with the low volume of the plant of the present invention, which is due to the principle of operation, as compared to currently known plants, the thermal energy generation with the plant of the present invention is accomplished using a heat pump and a modular thermal power plant. The heat pump and modular thermal power plant for this application have become technically thoroughly developed only in recent years. A modular thermal power plant today is available in standard forms for heating systems and can provide cheap heating energy and electrical current with a high degree of efficiency. Likewise, the heat pump can reduce the necessary heat demand by utilizing ambient energy. The heat pump is provided with electrical energy by the modular thermal power plant. The modular thermal power plant also provides the current for the pumps, control systems, and so forth associated with the plant. The heat pump preferably operates at temperatures up to 60° C. Such temperatures allow the heat pump to be used very efficiently even in the lower stages MSF chambers to reduce the temperature differences.

The improvements achievable with the plant of the present invention as compared to traditional plants include:
Sizing of the plant to actual demand, i.e. no overproduction
A small footprint
Progressive energy use
Use of the latest technologies in heat exchanger field
Operable as a standalone plant without any need for an associated power plant

The technical details of the improvements that are achievable with the present invention include:
Usage of energy recovery by the heat pumps
Balancing of the temperature curves in the pressure reduction stages between evaporation and heat recovery by condensation thereby avoiding potential losses
Highly efficient heat recovery using the most modern heat exchangers.

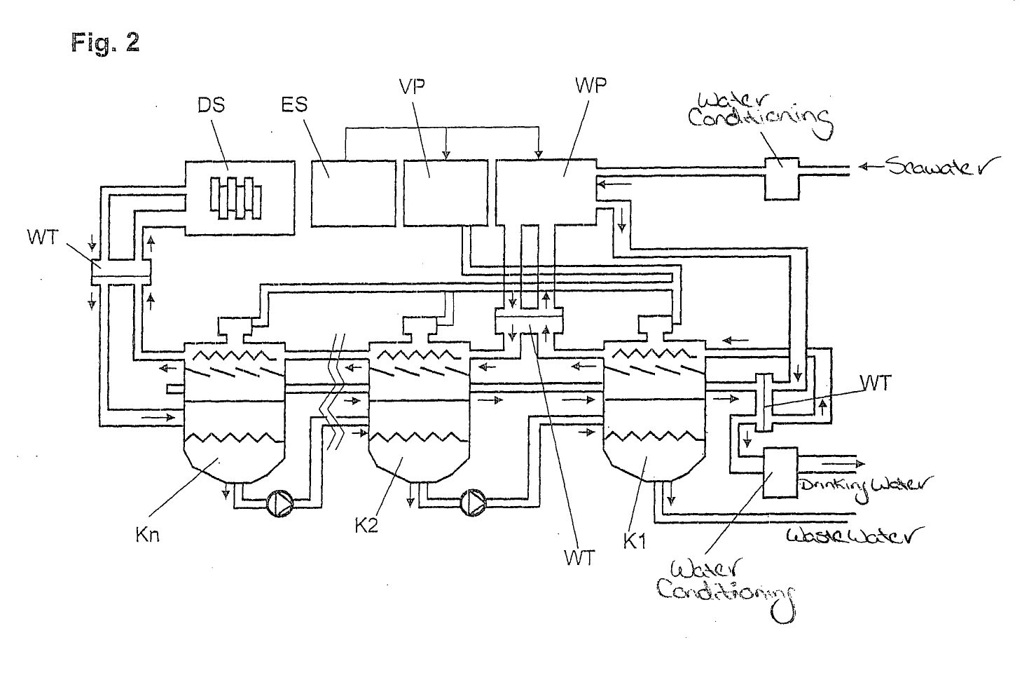

FIG. 2 provides a block diagram of a seawater desalination plant according to the present invention which includes a diesel generator DS, a heat pump WP and several heat exchangers WT connected in the circuit. The heat exchangers WT are connected in the liquid circulation of a cascading section of cascade vessels or units K1, K2, Kn. The cascade vessels K1, K2, Kn are connected via pressure regulators DR to a vacuum pump VP that generates the reduced pressure for evaporation of the seawater.

The heat pumps WP and the vacuum pumps VP are operated by an energy station ES. The diesel generator DS generates the electrical energy necessary for this. The resulting heat energy is transferred via a heat exchanger WT to the circulating liquid for further heating of the seawater. If desired, the diesel generator DS can be coupled to systems for using solar energy and/or the heat of waste steam.

An important aspect of the present invention is the additional heat transfer by the heat pump WP from the untreated water to the water being heated in the cascade vessels K1, K2, Kn. As will be appreciated, heating energy is saved and the efficiency of the process is substantially increased. Moreover, the heat pump WP can be switched and coupled with heat exchangers WT so that the residual energy contained in the pure water is withdrawn and introduced into the process of heating the seawater (see FIG. 2). Thus, the cooling that is necessary at the discharge location for the pure water is assisted. At the same time, the excess heat energy that is present in the pure water is used to minimize the energy needed by heat generators to heat the seawater for evaporation.

A combination of the methods is also possible by coupling the heat pump WP (preferably as a multistage arrangement) via heat exchanger WT to both the energy extraction location including the piping system for the feed water (seawater) and the piping system for the pure water. In this regard, several heat pumps WP can be used.

In this case, tube bundle type heat exchangers that have an efficient heat transfer medium can be used as heat exchangers WT to provide particular advantages. In particular, the use of such heat exchangers allows for improved transfer of the obtained heat.

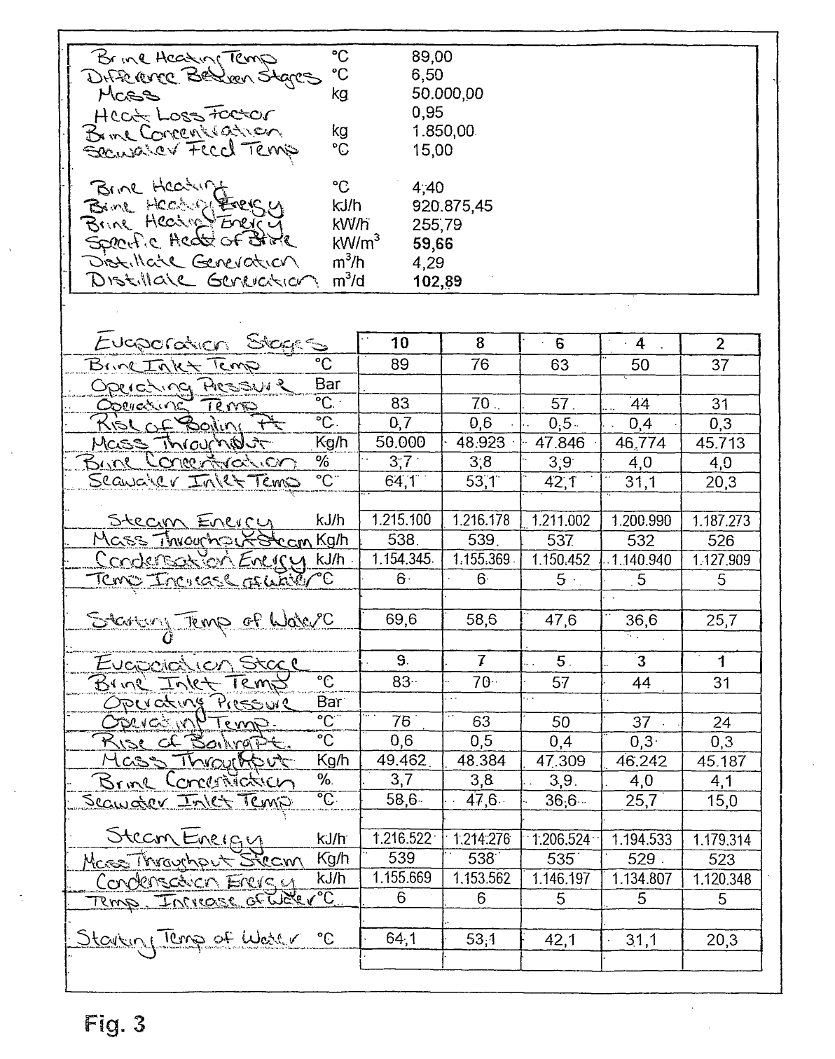

A particular result of the plant of the present invention is illustrated by a thermodynamic analysis of an MSF cascade as shown in the table of FIG. 3. In this case, the seawater temperature rises as it passes through the 10 cascade stages from 31 to 89° C. The increase of temperature from stage to stage is 5-6° C.

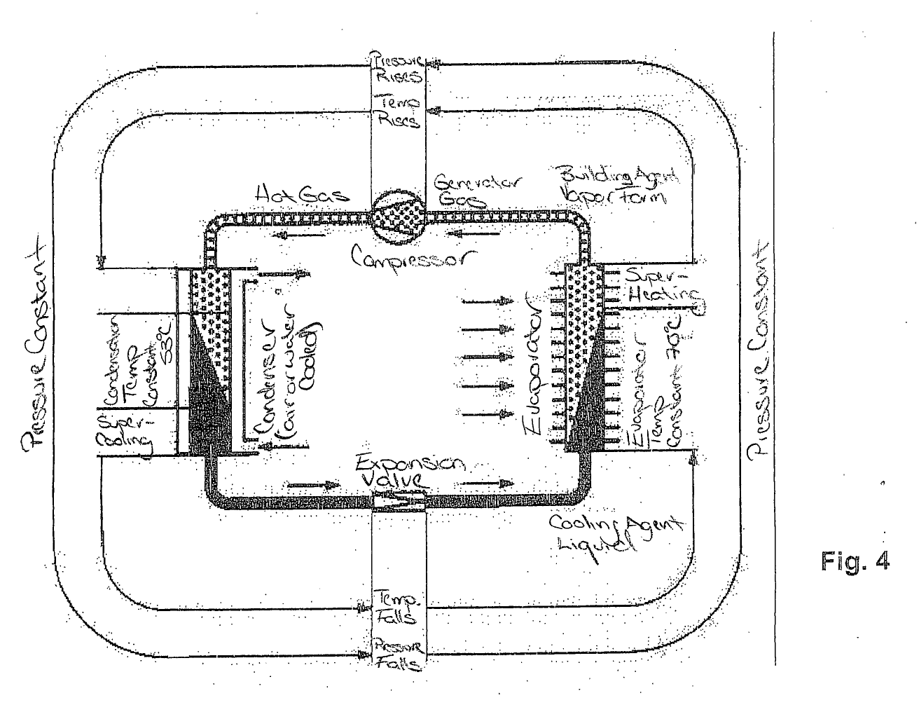

The heat pump used for the plant of the present invention can be of a known design. A schematic diagram of a suitable heat pump is provided in FIG. 4. Such heat pumps are well integrated into the field of seawater desalination plants and are well known. The illustrated heat pump is driven by an electrical supply from a diesel generator. This can be part of a modular thermal power plant.

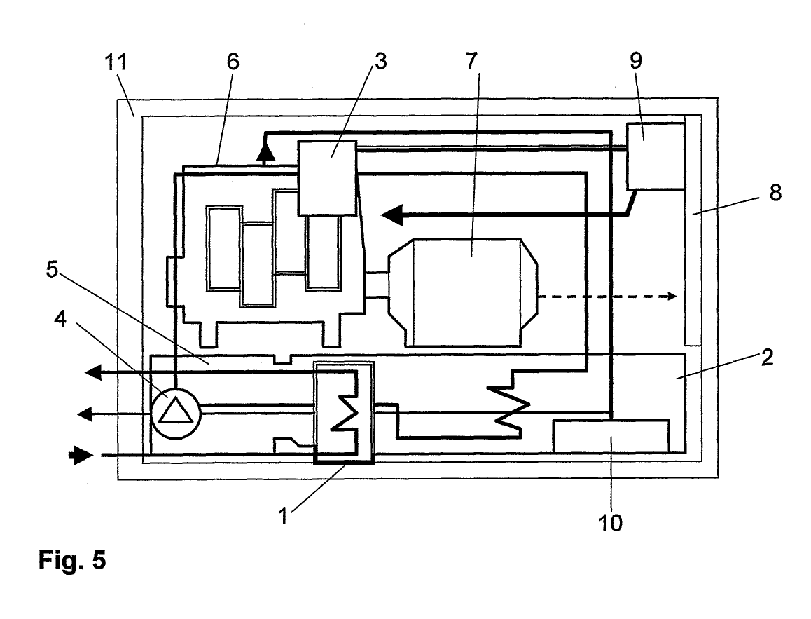

In the illustrated embodiment, a station for generating energy generation is designated as the diesel generator DS. A schematic diagram of the diesel generator DS is provided in FIG. 5. The diesel generator DS provides the necessary heat energy for operation of the MSF stages and the electrical current for the heat pump WP, the vacuum pump VP and the overall plant. Thus, except for the required fuel, the plant is completely self-sufficient and thus can even be operated in areas that are not developed. The diesel generator as shown in FIG. 5 includes the following elements:

1. Hot water heat exchanger

2. Waste gas heat exchanger

3. Lubricant cooler

4. Cooling water pump

5. Waste gas sound absorption

6. Gas engine

7. Generator

8. Control box

9. Lubricant tank

10. Starter battery

11. Sound absorption shroud

The described seawater desalination process can be broadened by using alternative heat pump arrangements. In particular, a closed circulation process can be achieved by broadening the previously described concept of a simple flowthrough system. With the closed circulation process, it is necessary to re-extract the heat energy supplied on the hot side of the seawater desalination plant on the cold side of the plant, otherwise the necessary temperature difference for re-condensation cannot be met. For this reason the heat pump WP supplies the evaporator on the cold water side from the outlet of cascade vessel K1. Heat pump WP then cools the purified water here and transfers the (otherwise lost) energy back to the hot side of the next cascade vessel K2, Kn of the evaporator. There the recovered energy is again available for heating the seawater that is to be purified. With such an arrangement, a substantial energy savings is possible. In previous systems, the cooling is carried out by means of freshwater and the energy is sent back to the sea and thus is lost.

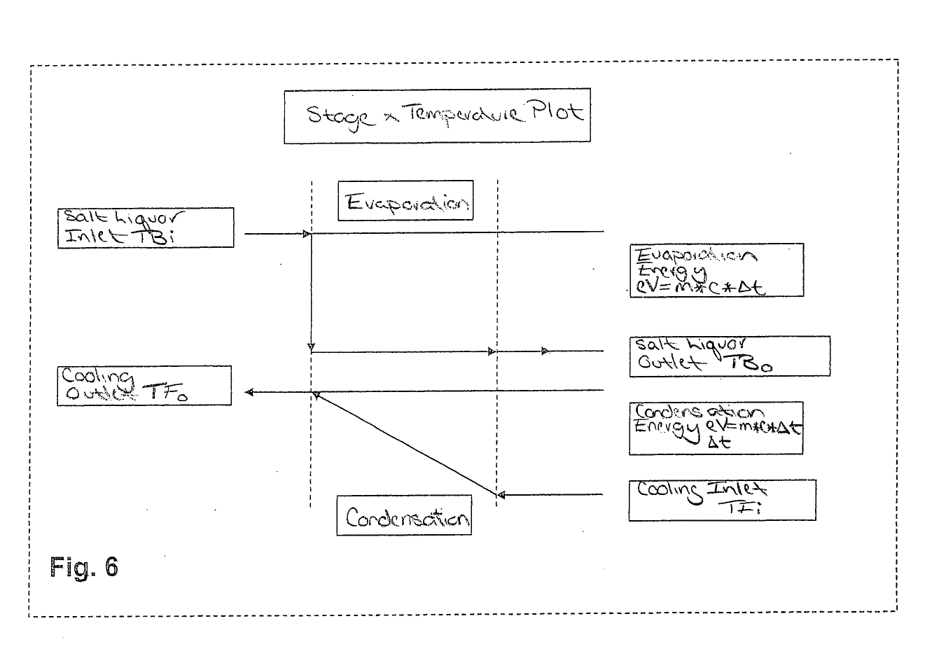

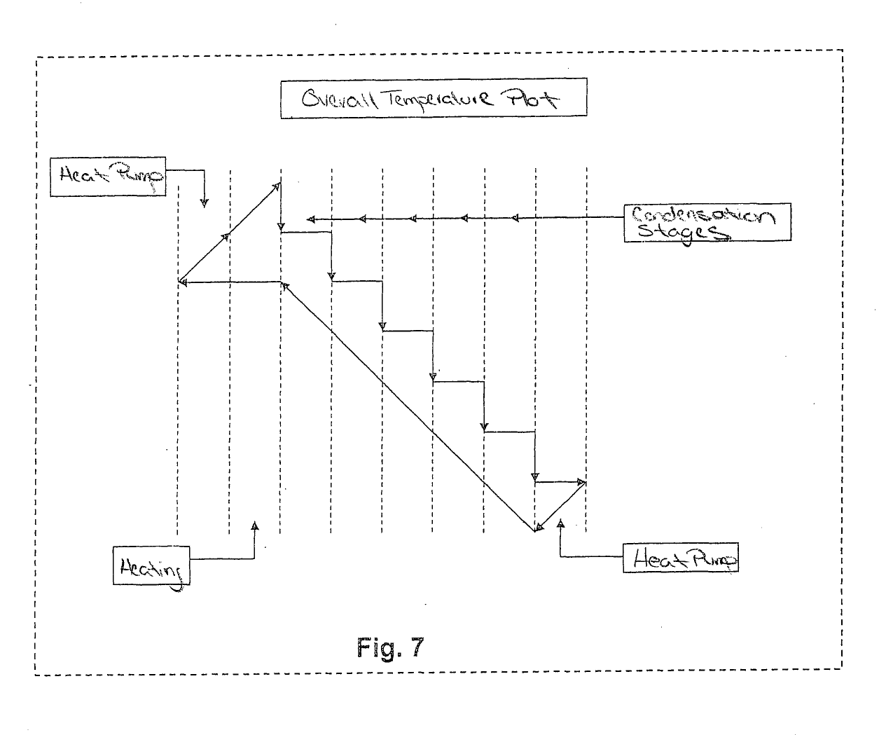

FIGS. 6 and 7 show the energy balance of such a plant. FIG. 6 shows that the energy of evaporation can be recovered from the condensation energy. The temperature elevation necessary for evaporation is produced by introduced energy of evaporation. At the same time, energy of condensation is released in the condensation of the pure water, so that the temperature again decreases. Although both processes run at different temperature levels, the released energy can be used to compensate for the required energy.

In FIG. 7, a heat pump is connected via a heat exchanger in the area of the purified water discharge pipe (see FIG. 2). The energy obtained at the purified water discharge can be introduced into the cascade section for heating the water to be evaporated. In FIG. 7, the decrease of temperature of the seawater over the cascade stages (condensation stages) is shown. The temperature of the pure water that is reached at the end of the cascade stages is reduced further via a heat exchanger for the heat pump. The recovered heat is introduced into the cascade stages by the heat pump at a higher temperature level to supplement—and at the same time reduce—the heat power required for evaporation.

1-8. (canceled)

9. A seawater desalination plant comprising:
a plurality of cascade units, each cascade unit being subjectable to a reduced pressure or heat for successively evaporating the seawater;
a first piping system supplying saltwater to the plurality of cascade units;
a second piping system for removing purified water from the cascade units;
a plurality of heat exchangers in the first piping system; and
a heat pump connected to at least one of the heat exchangers.

10. A seawater desalination plant as in claim 9 wherein the heat pump connects one of the plurality of heat exchangers that is located in a removal area for warm purified water to another one of the plurality of heat exchangers that is located in an unheated seawater feed area.

11. A seawater desalination plant as in claim 9 wherein the heat pump connects one or the plurality of heat exchangers that is located in a removal area for warm purified water to another of the plurality of heat exchangers which is located in an area for feeding partially heated seawater between two adjacent cascade units.

12. A seawater desalination plant as in claim 9 wherein one of the plurality of heat exchangers is coupled in an area for feeding substantially heated seawater feed area to a heat generator.

13. A seawater desalination plant as in claim 12 wherein the heat generator is a diesel generator.

14. A seawater desalination plant as in claim 13 wherein the heat pump is driven by the diesel generator.

15. A seawater desalination plant as in claim 9 wherein at least one of the plurality of heat exchangers comprises a high efficiency tube bundle heat exchanger with a heat transfer fluid.

16. A seawater desalination plant comprising:
a plurality of cascade units, each cascade unit being subjectable to reduced pressure or heat for successively evaporating the seawater
a first piping system for supplying salt water to the plurality of cascade units;
a second piping system for removing purified water from the cascade units;
a first heat exchanger arranged in a removal area for warm purified water and connected via a heat pump to a second heat exchanger in a supply area for unheated or partially heated seawater.

17. A seawater desalination plant as in claim 16 wherein the heat pump connects the first heat exchanger to a third heat exchanger which is located in an area for feeding partially heated seawater between two adjacent cascade units.

18. A seawater desalination plant as in claim 16 wherein the second heat exchanger is coupled in an area for feeding substantially heated seawater feed area to a heat generator.

19. A seawater desalination plant as in claim 18 wherein the heat generator is a diesel generator.

20. A seawater desalination plant as in claim 19 wherein the heat pump is driven by the diesel generator.

21. A seawater desalination plant as in claim 16 wherein at least one of the first and second heat exchangers comprises a high efficiency tube bundle heat exchanger with a heat transfer fluid.
